(19) United States
(12) Patent Application Publication
(10) Pub. No.: US 2025/0162824 A1
(43) Pub. Date: May 22, 2025

(54) METHOD AND DEVICE FOR AUTOMATICALLY STACKING PACKAGES ON A SUPPORT IN MULTIPLE LAYERS

(71) Applicant: Dematic GmbH, Heusenstamm (DE)

(72) Inventor: Hans Christoph Meurer, Framersheim (DE)

(21) Appl. No.: 18/838,414

(22) PCT Filed: Feb. 13, 2023
(86) PCT No.: PCT/EP2023/053510

§ 371 Date: Aug. 14, 2024

(30) Foreign Application Priority Data
Feb. 15, 2022 (DE) 10 2022 103 519.0

(51) Int. Cl. B65G 61/00

(52) U.S. Cl. CPC B65G 61/00; B65G 2203/0233; B65G 2207/46

(57) ABSTRACT

A device and method for automatically stacking packages with different dimensions on a support in a specified spatial arrangement includes determining the order and spatial position of packages with different dimensions in the stack to be formed on the support, arranging the packages on loading aids in the necessary order using a conveyor system, and transporting the packages from the conveyor system to the spatial positions which are calculated in advance on the support or on the stack being formed on the support by a handling means of a stacking device for forming the stack, where the handling means of the stacking device are designed to lift each package from the loading aid such that a gripper arranged on a robot arm grips and deposits at least one package at the calculated spatial position on the support or on the stack being formed on the support in one movement.

### CROSS REFERENCE TO RELATED APPLICATION

The present application is a national stage application of International Patent Application No. PCT/EP2023/053510, filed Feb. 13, 2023, and claims benefit of German patent application no. 10 2022 103 519.0, filed Feb. 15, 2022.

### BACKGROUND AND FIELD OF THE INVENTION

The invention relates to a method and a device for the automatic stacking of packing pieces on a base in a predetermined spatial arrangement to form a stack.

The automatic stacking of packing pieces on a base or a support, in particular a pallet or roll car, to form a stack for subsequent dispatch, i.e. “palletizing”, is known per se. However, in this regard packing pieces of uniform sizes or dimensions are placed at arithmetically determined locations by means of robots, grippers, etc. In contrast, the process of automatically loading a load support with packing pieces of different specifications for forming a stack is so-called automatic “mixed-case” palletizing.

Nowadays, in distribution logistics, ever greater demands are placed on the order-picking process. It is thus necessary to develop order-picking systems which process orders automatically without manual intervention. Thousands of different products (or different packing pieces) in a wide variety of different specifications (size, shape, weight, dimensions, surfaces, strength, compressibility, etc.) must be automatically picked by means of such systems. In this regard, different aspects must be considered which greatly increase the complexity compared with “simple” manual stacking of simple regular geometries. For instance, a subsequent packing piece can only be effectively stacked or placed on a previous packing piece if the latter has a flat or planar surface which should also be oriented approximately horizontally, and if the packing piece can carry the weight of the further packing pieces placed on it without being damaged. Furthermore, the formed stack should have a certain amount of stability, inter alia so that it does not topple over during transport. Although wrapping the stack with film is helpful, this alone cannot stabilize a poorly formed stack. Also, it is ever more frequently desirable for customers to have the stack optimized in terms of the desired unloading sequence.

Stacking of different packing pieces or goods of different sizes or dimensions thus occurs mostly by hand because the requirements of stability of the stack, the packing density within the stack, the loading sequence and the unloading sequence imposed thereby, and not least the stackability of the goods are extremely high and so far have not been fulfilled, or have only been fulfilled in part, by the known methods and devices.

The automatic stacking of packing pieces on a base or a support, in particular a pallet or roll car, to form a stack for subsequent dispatch, i.e. “palletizing”, is known per se. However, in this regard packing pieces of uniform size or dimension are placed at arithmetically determined locations by robots, grippers, etc. In contrast, the process of automatically loading a load support with packing pieces of different specifications for forming a stack is so-called automatic “mixed-case” palletizing.

EP 1 462 394 B1 discloses a device for automatically loading a load support with load stack-forming packing units, i.e. a device for palletizing. In the device, the packing units are supplied stored and singulated on trays, and from there are placed on a packing table. There, the packing unit, lying on the table, is moved by a pusher along the broad side of the pallet to be loaded, until the loading coordinates in the X direction are reached. Then, a further pusher and a loading tongue simultaneously push the packing unit in the direction of the load depth across the pallet until the loading coordinates in the Z direction are reached. Then, the loading tongue moves back and the pusher remains stationary and is used as a scraper so that the packing unit is set down on the pallet at the desired location in a “free falling” manner. The stack being formed is supported on the three other sides by a loading aid. It is thus stacked virtually “against the wall”. The packing units are unloaded from the so-called perforated trays prior to the movement on the packing table. The respective packing unit is thereby lifted from the perforated tray. The trays are fed for this purpose each with a packing unit lying thereon via a tray conveyor, at the end of which a plurality of lifting pins of a lifting device grip the packing unit through the multiple openings in the perforated tray from below and lift them out of the tray. Then, a rake grips the packing unit and pushes it onto the packing table.

WO 2010/059923 A1 discloses an automatic robot-assisted device for stacking, in which an intermediate plate is used for forming the first layer of a stack and for simultaneous pallet exchange.

DE 10 2007 046 919 A1 discloses a gripper for automatically gripping and placing packing units of different dimensions and configurations, having a support framework, to which a support, a hold-down device and a stripper are fastened, wherein the support is configured to be horizontally movable with respect to the support framework, the hold-down device is movable vertically in the direction of the support and so, by means of mechanical clamping, the packing unit can be pressed against the support and the stripper is arranged above the support and so the packing unit is secured when the support is withdrawn, wherein the stripper is configured to be movable horizontally in parallel with the support.

### SUMMARY OF THE INVENTION

The present invention provides an optimized method and a corresponding device for automatically stacking packages on a support in multiple layers.

In accordance with an embodiment of the invention, it has been recognized that when the unloading of the loading aids is combined with the placement of the packing pieces on the stack, it is possible to reduce the number of movement steps and thus to provide a more optimum method or a reduced movement sequence. In other words, the packing piece is handled only once because it is removed and palletized at the same time by the loading aid.

The handling means of the stacking device are specifically designed to lift the packing pieces in each case from the loading aid such that a gripper of the handling means arranged on a robot arm grips at least one packing piece and can place same at the precalculated spatial position on the support or the stack being formed on the support in one movement.

Possible grippers include suction grippers, clamping grippers or tine grippers. They can be arranged on a gantry robot or bent arm robot as a head and can be activated via the controller in order to remove the packing piece.

In a particular embodiment, the handling means of the stacking device are designed to lift the packing pieces in each case by means of a plurality of lifting pins of a lifting device through the multiple openings in the perforated tray from below to such an extent that a gap is produced between the perforated tray and packing piece and a tine gripper of the handling means arranged on a robot arm grips at least one packing piece (through the gap) and can place same at the precalculated spatial position on the support or the stack being formed on the support in one movement. It is thereby possible that the packing pieces are obtained in a singulated manner on the loading aids or perforated trays, or that a plurality of packing pieces are obtained on each loading aid or perforated tray. The gripper can then grip a predetermined number of packing pieces simultaneously or successively in order to place the packing pieces either individually or in groups.

In order to permit secure and rapid gripping, provision is made that, before the packing pieces are gripped, they are oriented on the loading aid or perforated tray (e.g. at a defined edge or corner). To this end, the loading aid or perforated tray can be tilted or rotated multiple times about different axes and so the packing piece slides against the respective edge and/or corner. To this end, correspondingly designed loading aid tilting means, loading aid rotation means can be provided. It is also possible to move the packing piece by means of pushers in a targeted manner to a predetermined position on the loading aid. A vibrating device can also be used in order to effect positioning of the packing piece.

Alternatively, by means of image recognition by camera and evaluation in the controller, the gripper can be activated in order to grip packing pieces which are not oriented and are optionally arranged on the perforated tray. This also makes it possible to identify the products or packing pieces and to select the desired packing piece from a plurality of packing pieces in a targeted manner by incorporating the product data from a warehouse management database.

Both make it possible for the gripper to pick up the packing piece in a defined packing piece orientation and thus place it precisely in the stack.

The control of the device is designed to activate the handling means arranged on a robot, in order to grip the respective packing piece on the loading aid and to place same at the precalculated spatial position on the support or the stack being formed on the support in one movement. In other words, the loading aid is not unloaded upstream as usual, but instead the unloading and placement in stacks are performed in one common step. This saves time and space.

In a particular embodiment, the device of the invention is designed having a controller which is designed to activate the lifting device such that the lifting pins are moved vertically upwards to such an extent that a gap is produced between the perforated tray and packing piece, and a tine gripper of the handling means arranged on a robot can be activated in order to grip the respective packing piece through the gap and to place same at the precalculated spatial position on the support or the stack being formed on the support in one movement. The lifting pins can be activated and raised collectively as one. Alternatively, it is also possible to collectively activate and raise only specific lifting pins which correspond e.g. to the known position of the packing piece.

Within the scope of the invention, a tine grippe may be used which, by means of the tines, can grip between the lifting pins in order to grip the packing piece(s) from below. Preferably, the tine gripper is configured for automatically gripping and placing packing units of different dimensions and different configurations, comprising a support framework, to which a support, a hold-down device and a stripper are fastened, wherein the support is configured to be horizontally movable with respect to the support framework, the hold-down device is movable vertically in the direction of the support and so, by means of mechanical clamping, the packing unit can be pressed against the support and the stripper is arranged above the support and so the packing unit is secured when the support is withdrawn, wherein the stripper is configured to be movable horizontally in parallel with the support, and the hold-down device is two-dimensional and the hold-down device has dimensions such that it extends over the entire surface of the support and the support is designed as a support plate or support comb having a plurality of spaced-apart tines, and the stripper has a horizontal wall which is provided with a rod-like structure and that the hold-down device is provided with cut-outs for engagement of the stripper therethrough. The hold-down device can have an elastic lining on its side facing the support. In a preferred embodiment the support framework is fastened to a gantry robot or bent arm robot.

On the whole, it is thus possible to stack items on the support in a flexible manner and at a high rate. In particular, a wide variety of different packing pieces can be stacked continuously. Therefore, in addition to the less challenging, uniform packing pieces which can of course likewise be handled, packing pieces with a wide variety of different dimensions can be successively stacked on the support.

The term “packing pieces” includes a wide variety of goods, packed goods, goods packed in groups, such as cartons, crates, boxes, containers, goods on trays, packing units, such as e.g. film multi-packs of plastic bottles, etc. and also individual items of all types.

The term “base” includes intermediate plates or supports, such as pallets and roll cars, or similar bases for unit loads and packages thereof.

The term “supply conveyor” includes conveyors in general and in particular roller conveyors, conveyor belts and conveying systems. These can be loaded manually or automatically. The packing pieces are singulated and delivered on the conveying equipment in the correct sequence for the desired packing sequence. The correct sequence is determined arithmetically when processing an order. Corresponding software for this is known.

It is expedient if the stack is stabilized on the support during and/or after stacking. Therefore, the individual layers retain their structure and the support with the stacked items thereon can be transported more securely. For the purpose of stabilizing after stacking (completely or individual layers) the stack can be stabilized together with the support with the stacked items thereon by wrapping it in a film, net or the like. Wrapping can occur gradually layer-by-layer during stacking or after stacking a layer. In this case, the stabilization takes place within the actual device for stacking. The support which already has some items stacked thereon is lowered layer-by-layer in order to adapt the level required for stacking. This is utilised because layers of the stack which are already formed “slide downwards” and can be wrapped layer-by-layer below the stacking level, while further stacking occurs “at the top”. This saves time. For this purpose, a film wrapping device is integrated directly into the device. This has the advantage that the support with the formed stack does not have to be moved separately. Therefore, stabilization can be effected each time a tier or layer has been lowered. As a consequence, a high degree of stability of the stack can be achieved even when items are not actually stacked on the support in a completely stable manner. This also significantly extends the options of stack formation in relation to the goods and the selectable sequence.

Of course, as an alternative to film wrapping technology, all other known stabilization options can be used. This includes e.g. film shrinkage, nets and other stretchable materials as well as hook-and-loop and adhesive joints etc.

During stacking itself, stabilization can be effected by means of lateral walls arranged in a U-shape around the stacking location or support and so stacking can be performed “against the wall”. Both the side walls and also the rear side wall can be adjusted or movable vertically and/or horizontally in relation to the stacking location. Therefore, supports etc. of a different size can be loaded and the walls can serve as a stripper in conjunction with intermediate plates.

Depending upon the packing pieces to be stacked, it may be necessary for protection thereof or in order to increase stackability etc. to place tiers, e.g. consisting of card or cardboard, between, below or above the layers. For this purpose, the planar material can be stored and/or supplied in a suitable manner and can be laid with suction cups provided on the handling means.

Both the support (e.g. pallets) and also the tiers (cardboard) can be supplied and provided via separate conveying equipment. Transfer of the support or tiers can be effected with dedicated technology.

In one embodiment, provision is made that an intermediate plate is provided at the level of the positioning conveyor above the support to be loaded. The intermediate plate provides a homogeneous smooth surface for stack formation and permits further stacking in spite of the exchange of supports. The intermediate plate is preferably divided centrally and each part is configured to be displaceable towards the side.

In one variant, the first tier of a stack is formed on the intermediate plate, whereas the completely loaded support of the preceding stacking procedure thereunder is exchanged for a new empty support. Therefore, the stacking process can be continued without interruption. If the first layer is formed and the new support is present, the parts are moved to the side and the first layer is thus transferred onto the underlying support, on which further stacking is subsequently performed.

In an alternative, the complete stacking procedure takes place on the intermediate plate and for this purpose it is designed to be variable in height. This has the advantage that the transfer to the support takes place only after stacking and the support does not have to be “exchanged”. As a result, the total throughput of the device is increased. In addition, the optionally provided wrapping with stretch film is to be performed more easily. When the intermediate plate is moved apart or opened, the lateral stabilization walls serve as a stripper, i.e. the intermediate plate moves laterally below the lower edges of the walls.

The provision of the stacked packing pieces in so-called roll cars or roll containers is promoted to a greater extent. They can be loaded easily into commercial vehicles and unloaded and moved on site because they have rollers. In addition, they have side walls which permit stable stacking and effective stabilization by means of stretch film so that transport is likewise secure. However, these properties cause difficulties during automatic stacking.

In accordance with aspects of the invention, it has been recognized that automatic stacking is reliably possible if the side walls of the roll car are held bent up at least vertically or even slightly obliquely to the outside by means of a spreading device. The side walls specifically have the property of moving inwards towards one another. It has also been found that the stacking of items on roll cars can be facilitated if, for this purpose, a separate and optionally height-adjustable intermediate plate is provided which is arranged on the side of the stacking location or support facing away from the positioning conveyor or can be introduced from this side into the roll car. This means that the device in accordance with the invention can be used to alternately stack items on pallets etc. or roll cars according to requirement.

The rear side wall can serve as a stripper when transferring the finished stack to the roll car by withdrawing the further intermediate plate. In one embodiment, the rear side wall is also movable in terms of height and/or is movable in the direction of the positioning conveyor, so that roll cars of different sizes can be used. The side wall may also preferably serve as an attachment location for the spreading device.

The spreading device in a preferred embodiment consists of two spigots which are arranged at the same height in the region of the expected side walls of the roll car, protrude forwards from the side wall into the roll car space and can be displaced laterally outwards for spreading purposes. Preferably, the spigots are each arranged for this purpose on a vertically oriented rotary disk in the rear side wall. For ease of transport and handling within the system, the roll cars are moved on transport pallets which can be handled like normal pallets.

Alternatively or in addition, the device can be designed having a unit for lowering/raising the support. This permits not only lowering after stacking of a tier but optionally also permits level control during actual stacking. Alternatively, the robot used is able to compensate for the increasing heights during stacking.

Further details of the invention will become clear from the following description of exemplified embodiments by reference to the drawings.

### BRIEF DESCRIPTION OF THE DRAWINGS

FIG. 1 shows a side view of an exemplified embodiment of a gripper used in accordance with the invention;

FIG. 2 shows a plan view of the gripper of FIG. 1;

FIG. 3 shows a front view of the gripper of FIG. 1;

FIG. 4 shows a perspective view of the gripper of FIG. 1; and

FIG. 5 shows a schematic view of a device for stacking a pallet having a gripper shown in FIG. 1.

### DESCRIPTION OF THE PREFERRED EMBODIMENTS

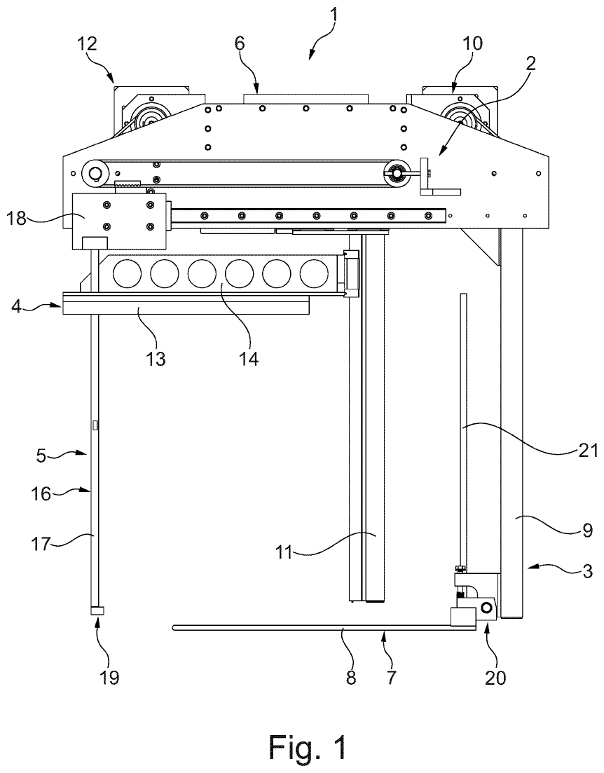

FIGS. 1-4 show a gripper—designated overall by 1, for automatically gripping and placing packing units of different dimensions and different configurations, which is used in particular in order to stack a wide variety of packing pieces on pallets or roll cars.

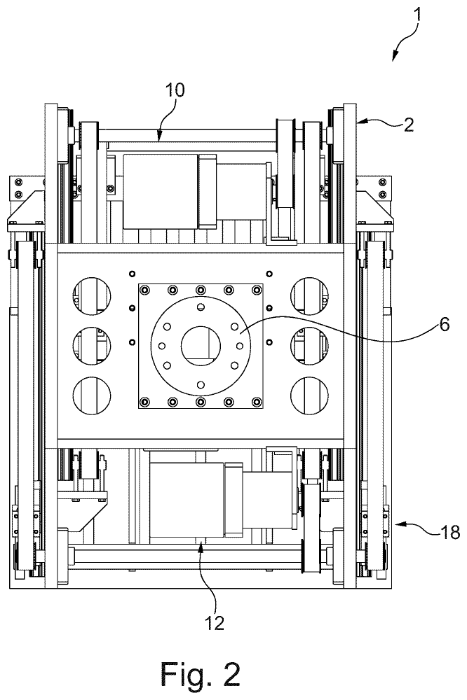

The gripper 1 comprises a support framework 2, to which a support 3, a hold-down device 4 and a stripper 5 are fastened. The support framework 2 also serves to fasten the gripper to a robot arm, not shown, for which reason a connecting plate 6 (see FIG. 2) is provided. The gripper 1 is also supplied with current via the robot.

In the present case, the support 3 is designed as a support comb 7 having a plurality of spaced-apart flat tines 8. For this purpose, the support comb 7 is fastened to the support framework 2 via a support arm 9 which extends approximately vertically downwards from the support framework 2. The support arm 9 and thus also the support comb 7 is movable horizontally with respect to the support framework 2 via an electric motor-driven belt drive 10 in order to effect release of the packing piece by withdrawing the support comb 7. In the figures, the support 3 is illustrated in a rear position.

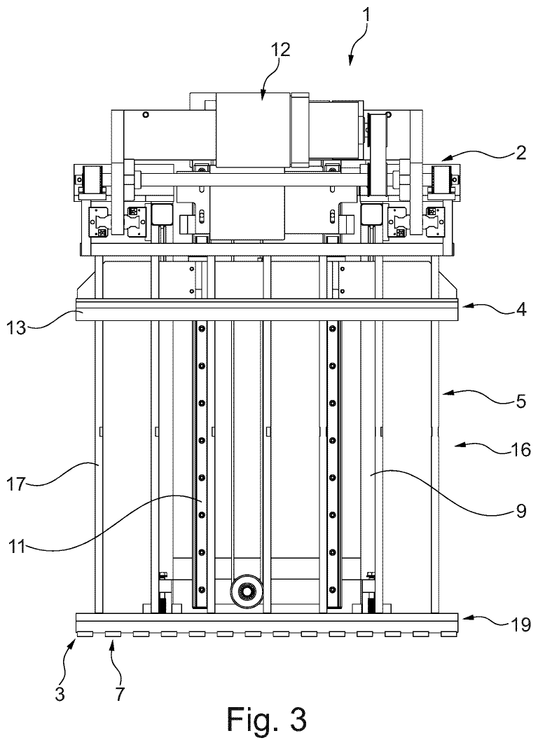

The hold-down device 4 is likewise fastened to a support arm 11 which extends approximately vertically downwards from the support framework 2, wherein this support arm 11 is designed to be stationary. On the support arm 11, the hold-down device 4 can be moved vertically in the direction of the support comb 7 in the manner of a carriage via a further electric motor-driven belt drive 12 (see FIG. 3) and so the distance between the hold-down device 4 and the support 3 or support comb 7 can be varied and the packing piece can be pressed against the support comb 7 by mechanical clamping. In the figures, the hold-down device 4 is illustrated in its uppermost position.

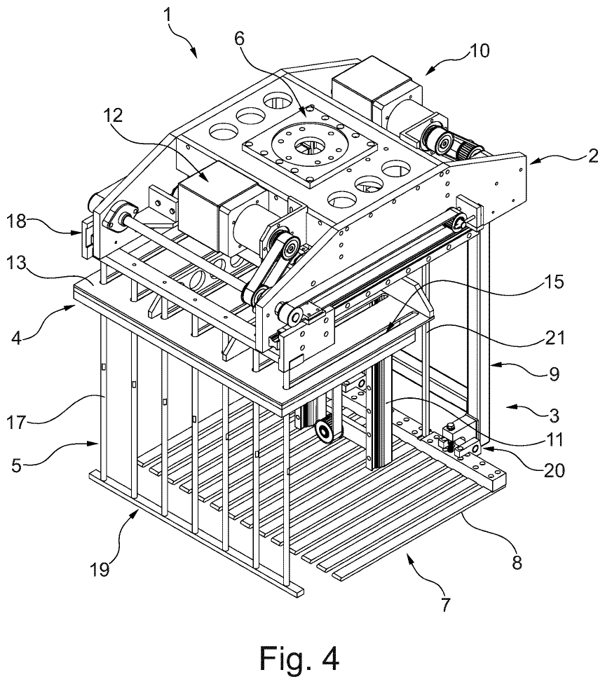

The hold-down device 4 is designed having a two-dimensional pressure element 13 which is fastened to the support arm 11 via a corresponding holding component 14 and acts on the corresponding packing piece. The two-dimensional pressure element 13 extends with its base surface over the corresponding active dimensions of the support comb 7. The hold-down device 4 is further provided with long hole-like cut-outs 15 (see FIG. 4) in the two-dimensional pressure element 13 for engagement of the stripper 5 therethrough.

The stripper 5 itself is arranged above the support 3 or the support comb 7 or the tines 8 and so, when the support 3 is withdrawn, the packing unit lies against the stripper 5 and is thus secured. In the figures, the stripper 5 is illustrated in its foremost position.

The force of the hold-down device is determined by measuring and monitoring the torque of the electric motor-driven belt drive 12.

In order to withdraw the packing piece, the stripper 5 has a horizontal wall 16 which is provided with a rod-like structure. The rods 17 of the horizontal wall 16 engage through the long holes/cut-outs 15 of the hold-down device 4 and issue in an electric motor-driven linear drive 18 at the support framework 2 which permits displaceability of the stripper 5 which is approximately horizontal and in parallel with the support 3. Therefore, it can be positioned according to the packing piece dimensions.

In order to stiffen the stripper 5, the rods 17 are connected to a cross-piece 19 on their side facing the support comb. The support comb 7 is fastened to the support arm 9 via a pretensioned joint 20 and so, when the support comb 7 is placed in contact, it can give way during the stacking procedure in order to protect the gripper 1. If contact is too hard, a release rod 21 which extends approximately perpendicularly from the joint 20 upwards in parallel with the support arm 9 strikes a corresponding sensor for an emergency stop.

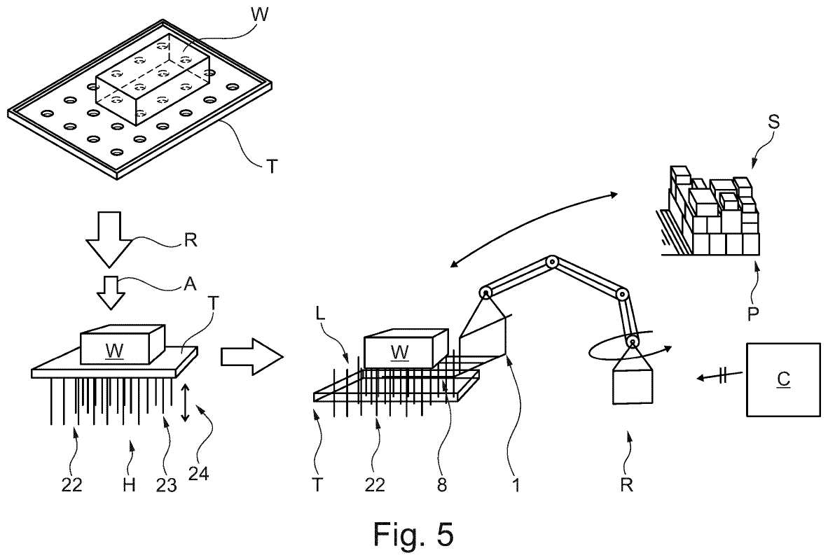

As illustrated schematically in FIG. 5, a perforated tray T is used for transporting the packing pieces W on conveying equipment, such as a roller conveyor F. The perforated tray T is thus conveyed to a stacking device where handling means H are designed to lift the packing pieces W in each case by means of a plurality of lifting pins 22 of a lifting device 23 through the multiple openings in the perforated tray from below to such an extent that a gap L is produced between the perforated tray T and the packing piece W (cf. image in the centre) and a tine gripper 1 arranged on a robot arm R, as described above, the handling means (H) engages at least one packing piece W, in which the tines 8 are introduced into the gap L between the lifting pins 22 in order to pick up the packing piece W from below, and to be able to place same at the precalculated spatial position on the support P or the stack S being formed on the support P in one movement.

The lifting pins 22 are thus designed to be guided in groups or collectively in a vertical manner from a drive as indicated by the arrow 24 through the holes in the perforated tray T in order to raise the packing piece W lying thereon so that a gap L is produced, into which the gripper can be introduced. To this end, the perforated tray T is oriented with an edge, not illustrated, so that the holes are arranged in accordance with the lifting pins 22 in the lifting device 23.

All of the steps take place under the supervision or control of the controller C.

The robot arm R is preferably a multi-axis bent arm robot.

In one variant, the packing piece W is oriented on the perforated tray T by tilting the tray T about a longitudinal edge and then by tilting same about an end face edge into a predetermined corner in a preceding step A by means of a double tilting means so that the gripper 1 can always pick up the packing piece W in the same manner.

In an alternative variant, the gripper 1 is designed, on the front edge of the hold-down device 4 or the two-dimensional pressure element 13, having a camera which, by means of image recognition and evaluation in the controller C with access to the product database of the packing pieces, permits recognition of the orientation and the targeted activation of the gripper 1 even without orientation.

In both cases, after being picked up the packing piece W is placed in one step onto the stack S on the support P or the pallet.

In contrast to the prior art, no prior unloading of the tray or shifting around of the package is required, but instead both take place in the same step or in the same movement.

1. A method for the automatic, multi-layered stacking of packing pieces of different dimensions on a support in a predetermined spatial arrangement to form a stack, comprising:
determining, in a computer-assisted manner, the sequence and spatial position of the packing pieces of different dimensions in the stack to be formed on the support;
obtaining the packing pieces supported on loading aids and in a sequence required for this purpose by conveying equipment;
transporting the packing pieces to be loaded from the conveying equipment to the precalculated spatial positions on the support or the stack being formed on the support by a package handling system of a stacking device to form the stack; and
lifting the packing pieces in each case from the loading aid such that a gripper of the package handling system arranged on a robot arm grips at least one packing piece and placing the at least one packing piece at the precalculated spatial position on the support or the stack being formed on the support in one movement.

2. The method as claimed in claim 1, wherein the packing pieces are obtained supported on perforated trays having multiple openings and the package handling system of the stacking device is designed to lift the packing pieces in each case by a plurality of lifting pins of a lifting device through the multiple openings in the perforated tray from below to such an extent that a gap is produced between the perforated tray and the packing piece, and wherein the gripper comprises a tine gripper for gripping the at least one packing piece and placing the at least one packing piece at the precalculated spatial position on the support or the stack being formed on the support in one movement.

3. The method as claimed in claim 1, wherein the packing pieces are obtained in a singulated manner on the loading aids.

4. The method as claimed in claim 1, wherein a plurality of packing pieces are obtained on each loading aid.

5. The method as claimed in claim 2, wherein the tine gripper grips a predetermined number of packing pieces simultaneously or successively.

6. The method as claimed in claim 1, further comprising orienting the packing pieces on the loading aid before gripping the packing pieces.

7. A device for the automatic, multi-layered stacking of packing pieces of different dimensions on a support in a predetermined spatial arrangement to form a stack, comprising:
a controller;
at least one supply conveyor configured to provide the packing pieces lying on loading aids in a predetermined sequence; and
a package handing system adjoining a discharge end of the supply conveyor configured to pick up the packing pieces from the supply conveyor and transport them to the predetermined position in the stack;
wherein the controller is configured to activate a gripper of the package handling system arranged on a robot to grip the respective packing piece on the loading aid and to place the packing piece at the precalculated spatial position on the support or the stack being formed on the support in one movement.

8. The device as claimed in claim 7, wherein the loading aids comprise perforated trays, and wherein the device further comprises a lifting device having a plurality of vertically movable lifting pins in an arrangement adapted to the multiple openings of the perforated trays, and wherein the controller is designed to activate the lifting device such that lifting pins are moved vertically upwards to such an extent that a gap is produced between the perforated tray and the packing piece, and wherein the gripper comprises a tine gripper and is configured to be activated in order to grip the respective packing piece through the gap and place same at the precalculated spatial position on the support or the stack being formed on the support in one movement.

9. The device as claimed in claim 8, wherein the tine gripper is configured for automatically gripping and placing packing units of different dimensions and different configurations, comprising a support framework, to which a support, a hold-down device and a stripper are fastened;
wherein the support is configured to be horizontally movable with respect to the support framework, the hold-down device is movable vertically in the direction of the support and, via mechanical clamping, the packing unit can be pressed against the support and the stripper is arranged above the support so that the packing unit is secured when the support is withdrawn, and wherein the stripper is configured to be movable horizontally in parallel with the support, such that the hold-down device is two-dimensional and that the hold-down device has dimensions such that it extends over the entire surface of the support, that the support is designed as a support plate or support comb having a plurality of spaced-apart tines, that the stripper has a horizontal wall which is provided with a rod-like structure and that the hold-down device is provided with cut-outs for engagement of the stripper therethrough.

10. The device as claimed in claim 9, wherein the hold-down device has an elastic lining on its side facing the support.

11. The device as claimed in claim 9, wherein the support framework is fastened to a gantry robot or bent arm robot.

12. The device as claimed in claim 8, wherein the hold-down device has an elastic lining on its side facing the support.

13. The device as claimed in claim 12, wherein the support framework is fastened to a gantry robot or bent arm robot.

14. A method for the automatic, multi-layered stacking of packing pieces of different dimensions on a support in a predetermined spatial arrangement to form a stack, comprising:
determining, in a computer-assisted manner, the sequence and spatial position of the packing pieces of different dimensions in the stack to be formed on the support;
obtaining the packing pieces supported on loading aids and in a sequence required for this purpose by conveying equipment;
transporting the packing pieces to be loaded from the conveying equipment to the precalculated spatial positions on the support or the stack being formed on the support by a package handling system of a stacking device to form the stack; and
lifting the packing pieces in each case from the loading aid such that a gripper of the package handling system arranged on a robot arm grips at least one packing piece and placing the at least one packing piece at the precalculated spatial position on the support or the stack being formed on the support in one movement;
wherein the packing pieces are obtained supported on perforated trays having multiple openings and the package handling system of the stacking device is designed to lift the packing pieces in each case by a plurality of lifting pins of a lifting device through the multiple openings in the perforated tray from below to such an extent that a gap is produced between the perforated tray and the packing piece, and wherein the gripper comprises a tine gripper for gripping the at least one packing piece and placing the at least one packing piece at the precalculated spatial position on the support or the stack being formed on the support in one movement, and wherein the tine gripper grips a predetermined number of packing pieces simultaneously or successively.

15. The method as claimed in claim 14, wherein the packing pieces are obtained in a singulated manner on the loading aids.

16. The method as claimed in claim 14, wherein a plurality of packing pieces are obtained on each loading aid.

17. The method as claimed in claim 14, further comprising orienting the packing pieces on the loading aid before gripping the packing pieces.
